(19) United States
(12) Patent Application Publication
(10) Pub. No.: US 2012/0240599 A1
(43) Pub. Date: Sep. 27, 2012

(54) AIR CONDITIONING SYSTEM FOR AN AIRCRAFT

(75) Inventor: Ralf-Henning Stolte, Hamburg (DE)

(73) Assignee: Airbus Operations GmbH, Hamburg (DE)

(21) Appl. No.: 13/424,966

(22) Filed: Mar. 20, 2012

Related U.S. Application Data
(60) Provisional application No. 61/454,700, filed on Mar. 21, 2011.

(30) Foreign Application Priority Data
Mar. 21, 2011 (DE) 10 2011 014 565.5

(51) Int. Cl. F25D 17/06; F17C 3/08

(52) U.S. Cl. 62/45.1; 62/89

(57) ABSTRACT

A cryogenic fluid from a cryogenic tank is used as a cooling medium for an air-conditioning system of an aircraft.

### CROSS-REFERENCE TO RELATED APPLICATIONS

This application claims the benefit of the filing date of U.S. Provisional Patent Application No. 61/454,700 filed Mar. 21, 2011, the disclosure of which is hereby incorporated herein by reference in its entirety.

### FIELD OF THE INVENTION

The invention concerns the treatment of air in aircraft. In particular, the invention pertains to an air-conditioning system for an aircraft, an aircraft, a method for operating an air-conditioning system and a use of a cryogenic fluid as a cooling medium.

### BACKGROUND OF THE INVENTION

Almost every aircraft, and passenger aircraft in particular, contains an air-conditioning system that can supply a cabin section of the aircraft accommodating, for example, passengers or the crew members of the aircraft, with prepared air. This air may need to, for example, contain the correct oxygen content, but it may need to also be of the right temperature and moisture content to ensure that the passengers and the crew members are comfortable.

An essential function of air-conditioning system is therefore the cooling of air. One possible way of cooling the air is to produce compressed air and to cool this using outside air drawn into the aircraft via a pressure pipe and then to reduce the pressure of the compressed air, during which the compressed air is cooled further. For this purpose, the compressed air is taken during the flight typically from one of the aircraft turbines. To ensure that sufficient cooled air is available while the aircraft is still on the ground, many aircraft comprise auxiliary systems for the generation of compressed air while the aircraft is on the ground and this compressed air can then be routed to the cooling system.

Nowadays, the trend is that most systems are operated electrically in an aircraft. In this way, an aircraft can comprise a fuel cell that generates electrical energy through the combustion of oxygen and hydrogen. The hydrogen used in the fuel cell can be taken from a cryogenic tank, in which typically 50 to 60 kg of hydrogen are stored in liquid form.

If the auxiliary system, which contributes to the generation of compressed air for the cooling system, is powered by an electric motor which is supplied with electricity by the fuel cell while the aircraft is on the ground, the fuel cell may have to be capable of supplying approximately 250 kW of electrical energy to operate the air-conditioning system while the aircraft is on the ground.

### BRIEF SUMMARY OF THE INVENTION

In this case, the fuel cell may have to be designed in such a way that it can still provide the necessary electrical energy to operate the air-conditioning system while the aircraft is on the ground. On the other hand, while the aircraft is in the air, the air can be cooled by the air drawn in from the engines, with the result that the fuel cell is required to generate considerably less electrical energy. For this reason, the electrical system of the aircraft is more generously designed than is actually necessary for operation during flight. Similarly, the conversion of hydrogen into electrical energy and the subsequent conversion of electrical energy into heat energy may be inefficient.

A first aspect of the invention concerns an air-conditioning system for an aircraft. In this sense, an aircraft can be an airplane, and in particular a passenger airplane.

In accordance with one embodiment of the invention, the air-conditioning system comprises a cooling system for the generation of cooled air for a cabin area of the aircraft, a cryogenic tank for the storage of a cryogenic fluid, whereby the cooling system serves to cool air by heating the cryogenic fluid.

The term cabin area can be understood to signify any area inside an aircraft in which persons or animals can be accommodated while the aircraft is on the ground or in the air. For example, the cabin area can include the cockpit, the passenger cabin and also an area that is set aside for the personnel or part of the freight area in which animals can be transported or which can be used by persons during the flight. A cryogenic tank may be any type of container that is suitable for storing a cryogenic fluid. In other words, a cryogenic tank may be a container that is insulated in such a way in relation to its surroundings that a cryogenic fluid that is stored in it does not significantly heat up over a prolonged period of time (for example, hours or days).

A cryogenic fluid may be a liquid or a gas that is very cold in relation to the ambient temperature, for example colder than −100° C. This could be liquid hydrogen with a temperature of, for example, less than about −253° C., liquid nitrogen with a temperature of less than about −195° C., or liquid oxygen with a temperature of less than about −183° C.

Because, while the aircraft is on the ground, the air is not only cooled by the auxiliary system, but also partially or completely cooled with the aid of the cryogenic fluid, which can be achieved through heat exchangers or by the direct injection of the cryogenic fluid into the air, it may be possible for the dimensions of the energy supply system to be smaller, as less energy needs to be supplied when the aircraft is on the ground, as the energy to cool the air (partially at least) is taken from the cryogenic tank. In this case, the electrical energy supply system in the aircraft will only need to supply around 100 kW of electrical energy, which will be used to power the other electrical systems of the aircraft. In this way, it may be possible to reduce the weight of these components of the aircraft.

In accordance with one embodiment of the invention, the cryogenic tank is so designed that it can store cryogenic hydrogen as a cryogenic fluid. A cryogenic tank of this type is usually already installed in an aircraft if a fuel cell is used to generate electrical energy from hydrogen. As the fuel cell normally does not require cryogenic hydrogen but hydrogen in gaseous form as a fuel, the cryogenic hydrogen is heated in the cryogenic tank to boiling point. This produces an overpressure in the cryogenic tank, which conveys the gaseous hydrogen in the direction of the fuel cell. In other words, it may be necessary to apply heat to the cryogenic tank or to its contents in order to be able to obtain cryogenic fluid, in this case hydrogen. This heat can be produced by taking heat from the air or vice versa by cooling the air by heating the cryogenic fluid. In this way, the heat energy required to heat the cryogenic fluid is not generated in the conventional manner by using—for example—an electrical heating element, but is taken from the air that in any case needs to be cooled for the air-conditioning system. This means that the energy consumption of the aircraft can be reduced.

In accordance with an embodiment of the invention, the air-conditioning system also comprises a heat exchanger system for conveying the heat from the air in the cooling system into the cryogenic fluid. This heat exchanger system can contain a heat exchanger inside the cryogenic tank, which, through a conduit system, through which a cooling agent flows, is connected to further heat exchangers, which are in contact with the air that is to be cooled. As the cryogenic tank is typically located in the tail section of the aircraft and the heat exchangers for cooling the air can be located at different points in the aircraft, the conduit system can contain heat-insulated conduits that pass through parts of the aircraft.

Normally, an aircraft with an air-conditioning system includes a mixer, into which on the one hand, outside air, which can be cooled by an expansion cooling system, and on the other recirculated cabin air from a cabin area of the aircraft, is passed. By means of the mixer, outside air, hot air and the recirculated cabin air are mixed and delivered to the cabin again.

In accordance with an embodiment of the invention, the fuel cell can also be so designed that it can generate heat for the air-conditioning system from the cryogenic hydrogen. By way of example, the waste heat from the fuel cell, which arises from the operation of the fuel cell, is used in order to heat water or air in the aircraft, such as for example the hot air for the mixer.

In accordance with an embodiment of the invention, the air-conditioning system can also comprise a mixer for mixing the outside air with the recirculated cabin air, whereby the heat exchanger system is so configured that it can cool the outside air and/or the recirculated air. For example, a heat exchanger can be positioned in the feed line of the outside air to the mixer which is connected to the heat exchanger in the cryogenic tank. It is also possible for a heat exchanger to be positioned in the conduit from the mixer to the cabin area, through which recirculated cabin air can be passed into the cabin, and also to be connected with the heat exchanger in the cryogenic tank.

In accordance with an embodiment of the invention, the air-conditioning system contains a heat exchanger system, which is so configured that it can heat outside air and/or recirculated air, which, for example, have been mixed in the above-mentioned mixer, by means of heat from the fuel cell. For this, a first heat exchanger can be installed close to or in the fuel cell and either before or after the mixer, a further heat exchanger, through which a cooling or a heating medium can be passed, is connected to the first heat exchanger.

Furthermore, it is also possible that the heat exchanger system is not only be used for cooling air, but for cooling other elements in the aircraft that need to be cooled.

In accordance with an embodiment of the invention, the air-conditioning system or the aircraft contains a heat exchanger system for the transfer of heat from a kitchen unit into the cryogenic fluid. By way of example, the kitchen unit includes a heat exchanger, which, by means of a conduit system or the conduit system containing a cooling medium, is connected to the heat exchanger in the cryogenic tank.

In accordance with an embodiment of the invention, the cooling system is so configured that it can cool compressed outside air by relaxation, whereby it is possible for the outside air to be compressed by a compressor, which can be provided with electrical energy by a fuel cell. In this way, part of the energy can be used to cool the air by heating the cryogenic fluid and part can be used to ensure that the heated cryogenic fluid is combusted in the fuel cell. Moreover, this system may be optimised in such a way that just as much cryogenic fluid is combusted in the fuel cell as is passed to the fuel cell by heating the cryogenic fluid in the tank and the associated increase in pressure.

Alternatively or additionally, the compressor can be supplied with electrical energy from a engine generator and/or also driven by tap air from an engine.

The heated cryogenic fluid does not necessarily have to be passed to a fuel cell. In accordance with an embodiment of the invention, it can be expelled into the outside air or also burned off there.

In accordance with an embodiment of the invention, the air-conditioning system is configured to store the cryogenic fluid heated by the cooling system in a metal hydride storage device. By way of example, this procedure may enable the balance between the generation of electricity and cooling energy to be achieved on a normal, standard day without any release of hydrogen.

On very hot days, in an air-conditioning system without a metal hydride storage device, in which hydrogen which is not consumed in the fuel cell but expelled into the outside atmosphere, it can happen that to generate the required cooling energy more hydrogen is expelled than is required for conversion into electrical power. In this case, where the air-conditioning system has a metal hydride storage system, the hydrogen that is not required for conversion into electrical power, can be temporarily stored in a metal hydride storage system and subsequently transferred to the fuel cell.

Furthermore, it is a characteristic of a metal hydride storage device that it heats up when being charged and cools down when being discharged. The heat generated during charging can be used, for example, to heat air or water in the aircraft. But the heat can also be used to remove the ice from the wing edges of an aircraft. For this reason, the metal hydride storage units could be positioned in the leading edge of the wing.

Conversely, the cold that is generated during the discharge of the metal hydride storage device can be used to cool air and water inside the aircraft.

The heated cryogenic fluid can still be relatively cool in comparison with the ambient temperature. For example, hydrogen in gaseous form can reach a temperature of −200° C. and nitrogen in gaseous form can reach a temperature of −150° C. In this way, the heated cryogenic fluid can also be used for cooling.

In accordance with an embodiment of the invention, the cooling system contains a heat exchanger, which is so designed that it can cool compressed outside air by means of ram air, whereby the cooling system is so designed that it can cool the ram air with the cryogenic fluid. By way of example, a mixture of cryogenic fluid and ram air in a heat exchanger can be routed past air that is to be cooled.

In accordance with an embodiment of the invention, the air-conditioning system also comprises a ram air channel, which is so designed that it can inject the cryogenic fluid into the ram air. For example, a nozzle can be positioned in the ram air channel, through which the cryogenic fluid can be blown into the ram air. The mixture of cryogenic fluid and ram air can be used to cool the compressed outside air.

As already indicated, it is also possible that the cryogenic tank is not a cryogenic hydrogen tank but a different cryogenic tank containing a different cryogenic fluid.

In accordance with an embodiment of the invention, the cryogenic tank is so designed that it can store cryogenic nitrogen, which is also used as an inert gas. In many aircraft, a cryogenic tank of this type is already available and is used to create an inert atmosphere at certain parts of the aircraft. For example, nitrogen can be used to reduce the inflammation of kerosene in the tanks.

A further aspect of the invention relates to an aircraft with an air-conditioning system, as described above and below. An aircraft of this type can also be equipped with a pneumatic air-conditioning system, in other words, an air-conditioning system that is operated by compressed air, which enables an air-conditioning system, as described above and below, to be subsequently fitted in existing aircraft. As, with the air-conditioning system in accordance with the invention, only a few additional components would need to be installed in the aircraft, so that the complexity in comparison with a conventional aircraft would be comparable.

Further requirements for the air-conditioning system can also be improved. In cases where the humidity level of the outside air is high, for example when the aircraft is on the ground in a tropical environment, it may be necessary for humidity to be extracted from the air, which will require additional energy. With the additional cooling by the cryogenic fluid, the air-conditioning system and its energy supply system can be so designed that this problem, which normally only occurs when the aircraft is on the ground, can be overcome. By way of example, a pleasantly ambient temperature and humidity level can be assured in the cabin area, even at a high outside temperature of, for example, 45° C. and a high level of air humidity, by heating the cryogenic fluid to a correspondingly high level.

Overall, it is also possible that the conventional components of the air-conditioning system are only designed for flight operation. In other words, the cooling of the outside air during flight is carried out by conventional components, such as a cooling unit in which the cooling of pressurized outside air is done by ram air from the outside, while additional cooling is provided by cryogenic fluid when the aircraft is on the ground.

A further aspect of the invention concerns a method for the operation of an air-conditioning system of an aircraft.

This means that features of the air-conditioning system and of the aircraft, as described above and below, can also be features of the method, and vice versa, that the air-conditioning system and the aircraft system are configured in such a way that they can carry out steps or features of the method.

In accordance with an embodiment of the invention, the process contains the step of adding cryogenic fluid to the aircraft. For example, this addition of cryogenic fluid can take place at the same time as the aircraft is being refuelled normally, for example with kerosene. At this time, the aircraft is, as a rule, on the ground and the cryogenic tank is refilled with cryogenic fluid.

In accordance with an embodiment of the invention, the process contains the step of cooling air for a cabin area of the aircraft with the cryogenic fluid. As already indicated, this step may only be carried out when the aircraft is on the ground. However, it is possible that such cooling with the cryogenic fluid may also be carried out when the aircraft is in the air. The cooling can be carried out directly by the injection of cryogenic fluid into the air that is to be cooled or indirectly through a heat exchanger system.

A further aspect of the present invention concerns the use of a cryogenic fluid from a cryogenic tank as a cooling medium for the air conditioning system of an aircraft. A cryogenic fluid can largely be distinguished from a conventional cooling medium in that the cooling circuit with a cryogenic has cooling temperatures that are significantly lower than those of the conventional cooling means, for example a temperature of less than −100° C. or −150° C. in comparison with the temperatures indicated above for cryogenic fluids.

Below, embodiments of the invention are explained in detail in the light of the attached drawings.

### BRIEF DESCRIPTION OF THE DRAWINGS

FIG. 1 shows a schematic plan view of an aircraft in accordance with an embodiment of the invention.

FIG. 2 shows a schematic diagram of an air-conditioning system in accordance with an embodiment of the invention.

FIG. 3 shows a flow diagram for a process for operating an air-conditioning system in accordance with an embodiment of the invention.

The reference numerals used in the drawings and their significance are shown in the attached List of Reference Numerals. In principle, identical or similar parts have the same reference numerals.

### DETAILED DESCRIPTION

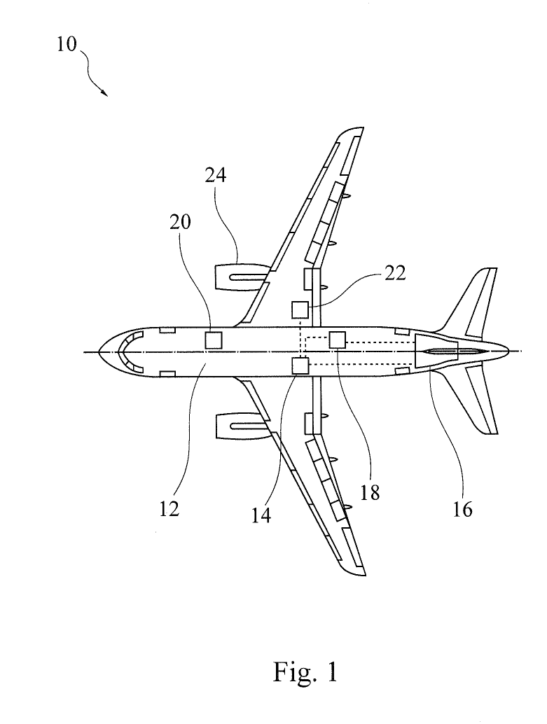

FIG. 1 shows an aircraft 10, for example a passenger aircraft 10, having a cabin area 12 in which the passengers can be accommodated. The aircraft 10 contains an air-conditioning system 14, which is so designed that a pleasant atmosphere is created within the cabin 12. Furthermore, the aircraft 10 comprises a cryogenic hydrogen tank 16 in a tail section of the aircraft 10, in which cryogenic hydrogen can be stored. The cryogenic hydrogen can be used to supply a fuel cell 18 with fuel. The cryogenic hydrogen in the tank 16 can also be used to cool air and water in the air conditioning system 14.

While the aircraft is in operation, the fuel cell 18 generates heat, which can be additionally used to heat air and water for the air-conditioning system 14.

The aircraft 10 can also comprise a cryogenic nitrogen tank 22, which can be filled with cryogenic nitrogen for use as an inert gas in the aircraft 10. The cryogenic nitrogen from the tank 22 can be used in the same as the cryogenic hydrogen from the tank 16 to cool the air and water for the air-conditioning system 14.

FIG. 1 also shows a kitchen unit 20 or galley 20 that can include cooling elements, such as a refrigerator, for example, which can also be cooled by the cryogenic fluid from one of the tanks 16, 22.

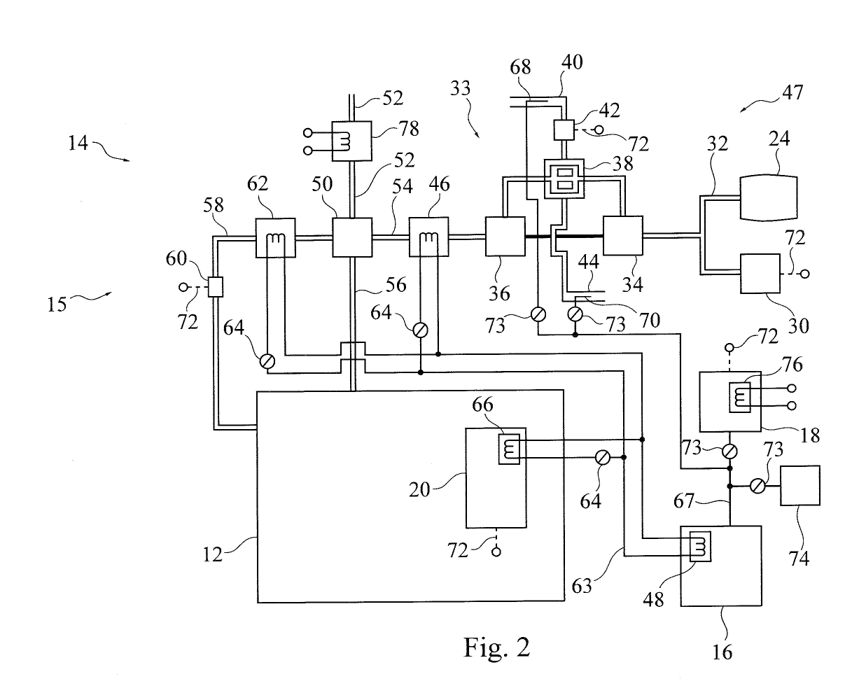

FIG. 2 shows in schematic form further details of the air conditioning system 14, and in particular the heating and cooling system 15 of the air-conditioning system 14.

The cooling system 15 comprises a relaxation cooling system 33, which is so designed as to cool the outside air, which can then ultimately be passed to the cabin 12 of the aircraft 10. The relaxation cooling system 33 works with compressed air, which can be taken during flight from an engine 24 of the aircraft 10 as tap air 32 or, while the aircraft is on the ground, can be generated by means of a compressor 30, which can be driven, for example, by an electric motor or an internal combustion engine. The air coming from the engine 24 or the compressor 30 is further compressed by a compressor 34, which is driven by a turbine 36. The air that is compressed in the compressor 34 is cooled by a heat exchanger 38 and then relaxed in the turbine 36, thereby creating mechanical energy, with which the compressor 34 can be driven.

In the heat exchanger 38, the compressed air from the compressor 34 is cooled by the outside air, which is introduced into the heat exchanger 38 by a ram pipe 40. While the aircraft is in flight, this can take place easily through the accumulated pressure of the air that reaches the ram pipe 40, although while the aircraft is on the ground it may be necessary for the outside air to be blown by a fan 42 through the heat exchanger 38. The air that is heated in the heat exchanger 38, leaves the aircraft 10 through an outflow 44.

The cooled air from the turbine 36 is then passed to a mixer 50, in which cooled air from the turbine 36, recirculated air 58, which can be drawn in by a fan 60 from the cabin area 12, and hot air 52 are mixed, producing an air mixture 56, the temperature of which is as required by the cabin area 12.

In the cryogenic hydrogen tank 16 there is a heat exchanger 48, which is connected through a conduit system 63, in which a cooling or a heating medium circulates, with a heat exchanger 46 that is positioned between the relaxation cooling system 33 and the mixer 50, and which is so designed that it continues to cool the outside air from the relaxation cooling system 33, and a heat exchanger 62, which is so configured that it cools the recirculated air 58 from the cabin 12.

The conduit system 63 can also be connected with a further heat exchanger 66, which is so configured that it cools a cooling element in the kitchen unit 20. The conduit system 63 can comprise a pump (not shown) and a valve 64, by which the flow of the cooling medium to the different heat exchangers 46, 62, 66 can be controlled.

The cryogenic hydrogen in the tank 16 can now be used to cool the cooling medium in the heat exchanger 48, which in turn cools the corresponding air in one or both of the heat exchangers 46, 62 and in so doing is heated to be subsequently returned to the heat exchanger 48 in the tank 16. In this way, the cryogenic hydrogen in the tank 16 is also heated and is partially transformed from a liquid to a gaseous phase, which produces a rise in pressure in the tank 16.

The gaseous hydrogen, which is conveyed by the pressure rise in the tank 16 into a conduit system 67 for hydrogen can then be transferred to the fuel cell 18, which then generates electrical energy from the hydrogen as fuel, which is then fed into an electrical supply system 72. The electrical energy that is generated by the fuel cell 18, can be routed through the electrical supply system 72 to the compressor 30 and to other electrical equipment, such as the fans 42 and 60.

Additionally, or alternatively, it is possible for the hydrogen from the tank 16 to be passed either in liquid or in gaseous form through the conduit system 67 to an injector 68, which is positioned in the ram pipe 40 of the relaxation cooling system. In this way, the relatively cool hydrogen from the tank 16 can be used to continue to cool the outside air drawn in through the ram pipe 40, so that the hydrogen from the tank 16 can also be used to cool the outside air from the ram pipe 40 in the heat exchanger 38.

By way of alternative, it is also possible for the hydrogen from the line 67 to be directly delivered into the atmosphere of the aircraft, for example by means of an outflow 70, which can be positioned in the outflow 44 for the accumulated air.

As a further possibility, the hydrogen from the tank 16 can be transferred to a metal hydride storage device 74 for intermediary storage. Surplus hydrogen that is forced into the conduit system 67 by the heating of the cryogenic hydrogen 16 can be stored in the metal hydride storage device 74 until a time when more electrical energy is required, so that more hydrogen is consumed than is created by heating in the tank 16. In this case, hydrogen can be returned from the metal hydride storage device 74 into the conduit system 67.

As already indicated above, the heat generated when charging the metal hydride storage device 74 and also the cold generated by discharging the metal hydride storage device 74 can be used to heat or to cool air in the air-conditioning system 14. By way of example, the metal hydride storage device can contain a heat exchanger, which is connected with the conduit system 63 and/or the heat exchanger 78. In order to control the inflow and the outflow of the hydrogen from the tank 16 to the metal hydride storage device 74 and to the two outflows 68, 70, the conduit system 67 comprises a number of valves 73, which can be controlled as necessary.

The heat generated by the fuel cell 18 when the aircraft is in operation can be used to heat or to cool the heating or the cooling system 15. For this purpose, the fuel cell 18 can contain for example a heat exchanger 76, which is connected to a further heat exchanger 78, with which the air 52, which is transferred to the mixer 50, can be heated.

The cooling of air with the cooling system 14 using cryogenic nitrogen from the cryogenic nitrogen tank 22, can take place in exactly the same manner as with the cryogenic hydrogen from the tank 16, whereby in FIG. 2, the tank 16 is replaced by the tank 22 and the liquid nitrogen cannot be transferred to the fuel cell 18 or the metal hydride storage device 74.

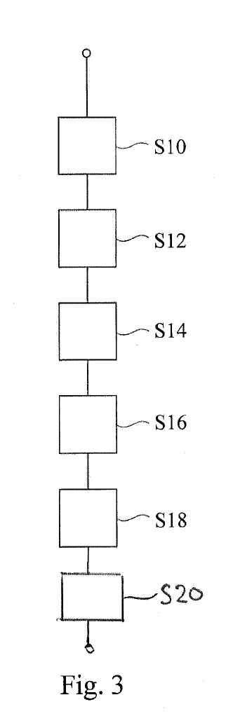

FIG. 3 shows a flow diagram for a method for operating the air-conditioning system 14.

The aircraft 10 is refuelled in a step S10. In this step, the cryogenic hydrogen tank 16, the cryogenic nitrogen tank 22 and other tanks (not shown) for conventional fuel can also be refilled. For this purpose, the aircraft 10 is normally on the ground.

In a step S12, the ground operation of the cooling system 14 is carried out. Here, the hydrogen from the tank 16 is burned in the fuel cell 18 and electrical energy is generated. This electric energy B used by the different on-board systems and also to operate the compressor 30, which produces compressed air for the relaxation cooling system 33. At the same time, some of the air already cooled by the relaxation cooling system 33 is further cooled by the heat exchanger 46, in which cryogenic hydrogen is heated in the tank 16. In this way, the pressure (or at least part of the pressure) is generated in the tank 16 that is required to supply hydrogen to the fuel cell 18.

Optionally, the recirculated air 58 from the cabin 12 can also be cooled through the heat exchanger 62 and also cooling elements in the galley 20 can be cooled by the cryogenic hydrogen. As already stated, as an alternative, the cooling can also be carried out by cryogenic nitrogen.

In addition, it is also possible to inject cold water through the nozzle 68 into the heat exchanger 38, in order to create further cooling of the compressed air from the compressor 34.

The aircraft starts at a step S14.

At a further step S18, the operation of the air-conditioning system 14 is switched from ground operation to airborne operation. The switch from airborne operation to ground operation (or vice versa) can also be carried out before starting. In airborne operation, there is, as a rule, less cooling of the outside air required as this is normally much colder than at ground level. For this reason, it is possible for the cooling of the outside air to be effected only through the relaxation cooling system 33 instead of by the cryogenic hydrogen from the tank 16.

By way of example, in step S18 the hydrogen stored in the metal hydride storage device 74 may also be returned to the conduit system 67, in order to be used in the fuel cell 18 to generate electrical energy.

In a step S20, the aircraft 10 lands. Shortly before the step S20 or shortly afterwards, the air-conditioning system 14 can be switched back to ground operation.

Finally, it should be noted that the terms “having/comprising” are not intended to preclude other elements or steps and that “a/an” does not preclude a plural form. It should be also noted that features or steps, described by means of references to one of the above embodiments, can also be used in combination with other features or steps of other embodiments described above. Reference numerals contained in the claims are not to be seen as being a limitation.

### LIST OF REFERENCE NUMERALS

10 Aircraft
12 Cabin
14 Air-conditioning system
15 Cooling system
16 Cryogenic hydrogen tank
18 Fuel cell
20 Galley (kitchen unit)
22 Cryogenic nitrogen tank
24 Drive unit
30 Compressor (driven by electric motor or combustion engine)
32 Tap air
34 Compressor
36 Turbine
38 Heat exchanger
40 Ram pipe
42 Fan
44 Outflow of ram air
46 Heat exchanger (optional)
47 Cooling system
48 Heat exchanger
50 Mixer
52 Hot air
54 Cooled fresh air
56 Mixed air
58 Recirculated air
60 Fan
62 Heat exchanger (optional)
63 Conduit system for cooling medium
64 Valve
65 Heat exchanger
67 Conduit system for hydrogen
68 Injector
70 Outflow
72 Electrical supply system
73 Valve
74 Metal hydride storage device
76 Heat exchanger
78 Heat Exchanger

1. An air conditioning system for an aircraft comprising:
a cooling system to produce cooled air for a cabin area of the aircraft, and
a cryogenic tank for storage of a cryogenic fluid,
whereby the cooling system is configured to cool air by heating the cryogenic fluid.

2. The air-conditioning system according to claim 1, wherein the cryogenic tank is configured to contain cryogenic hydrogen as the cryogenic fluid.

3. The air conditioning system according to claim 2, further comprising:
a fuel cell to generate at least one of electrical energy and heat for the air-conditioning system from the cryogenic hydrogen.

4. The air-conditioning system according to claim 1, further comprising:
a first heat exchanger system for the transportation of heat from the air in the cooling system into the cryogenic fluid.

5. The air-conditioning system according to claim 4, further comprising:
a mixer to mix outside air and re-circulated cabin air, wherein the first heat exchanger system is configured to cool the outside air and the recirculated air.

6. The air-conditioning system according to claim 3, further comprising:
a second heat exchanger system configured to heat at least one of the outside air and recirculated air by heat from the fuel cell.

7. The air-conditioning system according to claim 1, further comprising a compressor configured to receive electrical energy from a fuel cell,
wherein the cooling system is configured to cool compressed outside air by relaxation, and whereby the outside air is compressed by the compressor.

8. The air-conditioning system according to claim 1, further comprising:
a third heat exchanger system for transportation of heat from a kitchen unit into the cryogenic fluid.

9. The air-conditioning system according to claim 1, wherein the air-conditioning system is configured such that cryogenic fluid heated by the cooling system can be at least one of expelled into the outside air, burned off, and stored in a metal hydride storage device.

10. The air-conditioning system according to claim 1, wherein the cooling system contains a fourth heat exchanger, which is configured to cool compressed outside air by ram air; and
wherein the cooling system is configured to cool the ram air with the cryogenic fluid.

11. The air-conditioning system according to claim 10, further comprising:
a ram air channel configured to inject the cryogenic fluid into the ram air.

12. The air-conditioning system according to claim 1, wherein the cryogenic tank is configured to store cryogenic nitrogen.

13. An aircraft, having an air-conditioning system, the air-conditioning system comprising:
a cooling system to produce cooled air for a cabin area of the aircraft, and
a cryogenic tank for storage of a cryogenic fluid,
wherein the cooling system is configured to cool air by heating the cryogenic fluid.

14. A method for an operation of an air-conditioning system of an aircraft, comprising:
fueling of the aircraft with a cryogenic fluid, and
cooling air for a cabin area of the aircraft with the cryogenic fluid.
